(19) United States
(12) Patent Application Publication
(10) Pub. No.: US 2025/0145783 A1
(43) Pub. Date: May 8, 2025

(54) COMPOSITE MATERIAL LAMINATE AND EXTERIOR MATERIAL USING THE SAME

(71) Applicants: SK INNOVATION CO., LTD., Seoul (KR); SK GEO CENTRIC CO., LTD., Seoul (KR)

(72) Inventors: Wonchul JOO, Daejeon (KR); Sang Hee KIM, Daejeon (KR); Hyungbin KIM, Daejeon (KR); Junghwan SEO, Daejeon (KR); Kang Hyun SONG, Daejeon (KR); Seunghyun AHN, Daejeon (KR)

(21) Appl. No.: 18/595,445

(22) Filed: Mar. 5, 2024

(30) Foreign Application Priority Data
Nov. 2, 2023 (KR) 10-2023-0150007

(51) Int. Cl. C08J 5/24; B32B 5/02; B32B 5/12; B32B 5/18; B32B 5/24; B32B 37/24; B32B 38/08; C08J 5/12; C08J 7/12; C08K 5/17; C09D 7/48; C09D 7/63; C09D 167/06

(52) U.S. Cl. CPC C08J 5/244; B32B 5/022; B32B 5/12; B32B 5/18; B32B 5/245; B32B 37/24; B32B 38/08; C08J 5/121; C08J 7/123; C09D 7/48; C09D 7/63; C09D 167/06; B32B 2037/243; B32B 2255/02; B32B 2255/26; B32B 2260/023; B32B 2260/046; B32B 2262/0284; B32B 2262/101; B32B 2305/076; B32B 2305/18; B32B 2307/304; B32B 2307/4026; B32B 2307/54; B32B 2307/712; B32B 2307/718; B32B 2307/748; B32B 2605/00; C08J 2323/12; C08J 2367/06; C08K 5/17

(57) ABSTRACT

A composite material laminate, replaceable with a metal panel for an exterior material, comprises a fiber-reinforced composite material including a sheet-shaped composite material in which a thermoplastic resin is impregnated in a reinforcing fiber which is continuous and oriented in one direction; a weather-resistant coating layer disposed on one surface of the fiber-reinforced composite material; and a non-woven fabric layer disposed on the other surface of the fiber-reinforced composite material, which is present invention disclosure has light, high strength, low surface roughness to have excellent aesthetics, and excellent durability and weatherability.

### CROSS-REFERENCE TO RELATED APPLICATIONS

This application claims priority under 35 U.S.C. § 119 to Korean Patent Application No. 10-2023-0150007, filed on Nov. 2, 2023, in the Korean Intellectual Property Office, the disclosure of which is incorporated herein by reference in its entirety.

### TECHNICAL FIELD

The following s generally to a composite material laminate and an exterior material using the same.

### BACKGROUND

A sandwich panel is being applied to various fields such as exterior materials for buildings or containers for freight transportation.

A commonly used exterior material is formed of a structure in which a metal plate material and an insulating material are laminated. However, the metal plate material is heavy and prone to external damage by nicks and the like.

Therefore, a study for replacing a conventional metal plate material is demanded.

### SUMMARY

An embodiment of the present invention is directed to providing a composite material laminate which has high enough strength to replace a metal plate material which is conventionally used as an exterior material and may have reduced weight.

Another embodiment of the present invention is directed to providing a composite material laminate which has excellent weatherability and durability and low surface roughness, and thus, has excellent aesthetics.

Still embodiment of the present invention is directed to providing a composite material laminate which may further improve binding force when laminated with an insulating material.

In one general aspect, a composite material laminate includes: a fiber-reinforced composite material including a sheet-shaped composite material in which a thermoplastic resin is impregnated in a reinforcing fiber which is continuous and oriented in one direction; a weather-resistant coating layer disposed on one surface of the fiber-reinforced composite material; and a non-woven fabric layer disposed on the other surface of the fiber-reinforced composite material.

In an embodiment, the fiber-reinforced composite material may include a surface-treated layer which is plasma or corona-treated on a surface on which the weather-resistant coating layer is disposed.

In an embodiment, the weather-resistant coating layer may be formed of a composition including an unsaturated polyester resin and a hindered amine-based light stabilizer.

In an embodiment, the weather-resistant coating layer may have a thickness of 60 to 100 μm, but is not limited thereto.

In an embodiment, the weather-resistant coating layer may further include a white pigment.

In an embodiment, the non-woven fabric may have a basis weight of 40 g/m² or more, but is not limited thereto.

In an embodiment, the fiber-reinforced composite material may be a laminate of three or more layers of the sheet-shaped composite material in which a thermoplastic resin is impregnated in a reinforcing fiber which is continuous and oriented in one direction.

In an embodiment, the fiber-reinforced composite material may be a laminate of two or more layers of the sheet-shaped composite material in which the fiber orientations of the layers cross each other.

In an embodiment, in the lamination, the fiber orientations of the layers may cross each other at an angle of 0° or 90°.

In an embodiment, the fiber-reinforced composite material may have a reinforcing fiber content of 50 to 80 wt %, but is not limited thereto.

In an embodiment, the thermoplastic resin of the fiber-reinforced composite material may be polyethylene or polypropylene, but is not limited thereto.

In another general aspect, an exterior material includes the composite material laminate according to the embodiment and a foam.

In an embodiment, in the exterior material, the non-woven fabric layer of the composite material laminate may be laminated to face the foam on at least one surface of the foam.

In still another general aspect, a method of manufacturing a composite material laminate includes: laminating a non-woven fabric on one surface of a fiber-reinforced composite material in which two or more layers of a sheet-shaped composite material are laminated by thermal compression; and applying a composition including an unsaturated polyester resin and a hindered amine-based light stabilizer on the other surface of the fiber-reinforced composite material to form a weather-resistant coating layer, wherein the sheet-shaped composite material is formed by impregnating a thermoplastic resin in a reinforcing fiber, and wherein the reinforcing fiber is continuous and oriented in one direction.

In an embodiment, before forming the weather-resistant coating layer, hydrophilicizing the surface of the fiber-reinforced composite material may be further included.

In an embodiment, the hydrophilicizing may be a plasma or corona treatment.

Other features and aspects will be apparent from the following detailed description, the drawings, and the claims.

### BRIEF DESCRIPTION OF THE DRAWINGS

FIG. 1 is a cross-sectional view illustrating a lamination structure of a composite material laminate according to the present invention disclosure.

FIG. 2 illustrates an evaluation process of adhesion between a urethane foam and the composite material laminate according to the present invention disclosure.

FIG. 3 shown a cross section photograph of Example 8.

FIG. 4 shown a Photograph of specimen after penetration evaluation of Example 8.

FIG. 5 shown a cross section photograph of Comparative Example 4.

FIG. 6 shown a Photograph of specimen after penetration evaluation of Comparative Example 4.

### DETAILED DESCRIPTION OF EMBODIMENTS

Hereinafter, the present invention disclosure will be described in detail. However, it is only illustrative and the present invention disclosure is not limited to the specific embodiments which are illustratively described in the present invention disclosure.

In addition, unless otherwise defined, all technical terms and scientific terms have the same meanings as those commonly understood by one of those skilled in the art to which the present invention disclosure pertains. The terms used herein are only for effectively describing a certain specific example, and are not intended to limit the present invention disclosure.

In addition, the singular form used in the specification and claims appended thereto may be intended to include a plural form also, unless otherwise indicated in the context.

In addition, unless particularly described to the contrary, “comprising” any elements will be understood to imply further inclusion of other elements rather than the exclusion of any other elements.

In addition, unless particularly defined, when a layer or member is positioned “on” another layer or member, not only the layer or member is in contact with another layer or member, but also another layer or member exists between two layers or two members.

In addition, when unique manufacture and material allowable errors are suggested in the mentioned meaning, “about”, “substantially”, and the like are used in the meaning of the numerical value or in the meaning close to the numerical value, and are used for preventing the disclosure mentioning a correct or absolute numerical value for better understanding of the present invention disclosure from being unfairly used by an unconscionable infringer.

An embodiment of the present invention disclosure provides a composite material laminate including: a fiber-reinforced composite material including thermoplastic resin and a reinforcing fiber; a weather-resistant coating layer disposed on one surface of the fiber-reinforced composite material; and a non-woven fabric layer disposed on the other surface of the fiber-reinforced composite material.

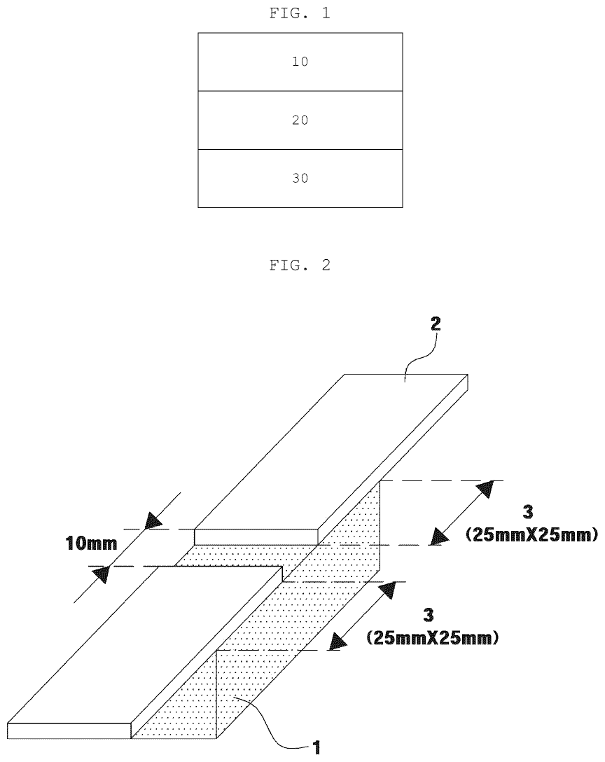

In an embodiment, the composite material laminate may include a weather-resistant coating layer 10, a fiber-reinforced composite material 20, and a non-woven fabric layer 30, which are sequentially laminated, as shown in FIG. 1.

In addition, though not shown separately, since one or both surfaces of the fiber-reinforced composite material 20 are hydrophilicized, a surface-treated layer may be formed, force between the fiber-reinforced and thus, a binding composite material 20 and the weather-resistant coating layer 10 or a binding force between the fiber-reinforced composite material 20 and the non-woven fabric layer 30 may be further improved. The hydrophilicization may be for reinforcing a chemical bond or a physical bond between the fiber-reinforced composite material and the weather-resistant coating layer. Without limitation, a plasma treatment and the like may be used.

In addition, though not shown separately, a protective film may be further included on the weather-resistant coating layer 10. The protective film is used for protecting the surface of the weather-resistant coating layer and facilitating transportation, and may be used without limitation as long as it is commonly used in the art. For example, a polyester-based film may be used.

FIG. 1 is illustrating an example embodiment of the present invention disclosure, and the composite material laminate of the present invention disclosure is not limited thereto.

The composite material laminate of the present invention disclosure may provide better mechanical properties by a combination of the lamination configurations. Specifically, for example, the composite material laminate of the present invention disclosure may provide excellent durability and tensile strength even in a state of advanced aging by long time sunlight exposure. For example, in tensile strength evaluation after an accelerated weathering treatment, physical properties of a tensile strength retention rate of 70% or more may be achieved.

Hereinafter, an example lamination configuration of the present invention disclosure will be described in more detail.

### Weather-Resistant Coating Layer

In an embodiment of the present invention disclosure, the weather-resistant coating layer 10 may be formed over the surface of the fiber-reinforced composite material 20 for protecting the fiber-reinforced composite material 20 as a substrate layer and adjusting the surface roughness of the fiber-reinforced composite material 20 for improved aesthetics.

In an embodiment, the weather-resistant coating layer 10 may be formed of a composition including an unsaturated polyester resin and a hindered amine-based light stabilizer.

By forming the weather-resistant coating layer 10 using the unsaturated polyester resin in the weather-resistant coating layer 10, the weather-resistant coating layer 10 may have a surface which is smooth, and has an excellent binding force, strong durability, and improved aesthetics when combined with the fiber-reinforced composite material 20.

The unsaturated polyester resin may be a resin mixture including an unsaturated polyester polymer and a vinyl-based monomer. In addition, the unsaturated polyester polymer may refer to a compound in which the type of unsaturated polyester polymers described below has a weight average molecular weight of 2000 g/mol or more or 3000 g/mol or more. For example, the unsaturated polyester resin may include 60 to 75 wt % of the unsaturated polyester polymer and 25 to 40 wt % of the vinyl-based monomer. The unsaturated polyester resin may be a viscous solution formed of the unsaturated polyester polymer diluted in the vinyl-based monomer. Therefore, by satisfying the content of the vinyl-based monomer to the range described above, the viscosity of the unsaturated polyester resin is decreased, so that it may be easier to handle the unsaturated polyester resin. The vinyl-based monomer may cure the unsaturated polyester resin from a liquid to a solid by crosslinking of a polyester molecular chain, without production of by-products.

The type of unsaturated polyester polymer is not particularly limited, and may for example, an unsaturated polyester polymer produced by a condensation reaction of saturated or unsaturated dibasic acids; and polyhydric alcohol may be used. The saturated or unsaturated dibasic acid may be ortho-phthalic acid, isophthalic acid, anhydrous maleic acid, citraconic acid, fumaric acid, itaconic acid, phthalic acid, anhydrous phthalic acid, terephthalic acid, succinic acid, adipic acid, sebacic acid, or tetrahydrophthalic acid. In addition, the polyhydric alcohol may be ethylene glycol, diethylene glycol, triethylene glycol, propylene glycol, dipropylene glycol, tripropylene glycol, polypropylene glycol, 1,3-butylene glycol, hydrogenated bisphenol A, trimethylol propane monoarylether, neopentyl glycol, 2,2,4-trimethyl-1,3-pentadiol, and/or glycerin. In addition, if necessary, a monobasic acid such as acrylic acid, propionic acid, or benzoic acid; or a polybasic acid such as trimellitic acid or tetracarbonic acid of benzole may be further used.

The type of vinyl-based monomer may be alkyl acrylate monomers or aromatic vinyl-based monomers, but considering the reactivity with the unsaturated polyester polymer, an aromatic vinyl-based monomer may be used. For example, the aromatic vinyl-based monomer may be one or more selected from the group consisting of styrene, α-methylstyrene, p-methylstyrene, vinyl toluene, alkylene styrene substituted by an alkyl group having 1 to 3 carbon atoms, and styrene substituted by halogen. For example, the type of vinyl-based monomer may be a styrene monomer.

A single-type or a mixture of multiple-types (multi-finctional) of the hindered amine-based light stabilizer (HALS) may be used. The light stabilizer refers to an additive material having light blocking properties by removing a radical produced by light incident from outside to prevent a photooxidation reaction of a binder resin composition by the radical. In an embodiment, the light stabilizer may be included at 0.1 parts by weight to 3 parts by weight with respect to 100 parts by weight of the unsaturated polyester resin, but is not limited thereto. Within the above-described content range, physical properties of excellent weatherability are expressed, and the range is sufficient not to affect durability and color, and thus, the light stabilizer may be appropriately used. The hindered amine-based light stabilizer may include a N—OR (alkoxy group) type, a N—H (hydrogen atom) type, a N—R (alkyl group) type, or the like.

For example, the N—OR type hindered amine-based light stabilizer may include a NOR-type hindered amine-based light stabilizer system (Tinuvin® PA123 available from BASF), a NOR-type hindered amine-based light stabilizer system (Tinuvin® XT850FF available from BASF), a weatherability stabilizer system based on a NOR-type hindered amine-based light stabilizer system (Tinuvin® 855FF available from BASF), a reaction product of peroxidized 4-butylamino-2,2,6,6-tetramethylpiperidine with 2,4,6-trichloro-1,3,5-triazine, cyclohexane, N,N′-ethane-1,2-diylbis(1,3-propanediamine) (Flamestab® NOR116FF available from BASF), or bis(1-undecaneoxy-2,2,6,6-tetramethylpiperidin-4-yl) carbonate (LA-81 available from ADEKA).

The N—H type hindered amine-based light stabilizer may include a N—H-type hindered amine-based light stabilizer system (N30 available from CLARIANT), tetrakis(1,2,2,6,6-pentamethyl-4-piperidyl) butane-1,2,3,4-butanetetracarboxylate (ADK STAB LA-57 available from ADEKA), bis(2,2,6,6,-tetramethyl-4-piperidyl) sebacate (TINUVIN 770DF available from BASF), N,N′-bis(2,2,6,6-tetramethyl-4-piperidyl)-N, N′-diformylhexamethylenediamine (UVINUL 4050FF available from BASF), a polycondensate of dibutylamine·1,3,5-triazine·N,N′-bis(2,2,6,6-tetramethyl-4-piperidyl)-1,6-hexamethylenediamine with N-(2,2,6,6-tetramethyl-4-piperidyl)butyl amine (CHIMASSORB 2020FDL available from BASF), poly [{6-(1,1,3,3-tetramethylbutyl)amino-1,3,5-triazin-2,4-diyl} {(2,2,6,6-tetramethyl-4-piperidyl)imino} hexamethylene {(2,2,6,6-tetramethyl-4-piperidyl)imino}] (CHIMASSORB 944FDL available from BASF), or olefin (C20-C24)·anhydrous maleic acid·4-amino-2,2,6,6-tetramethylpiperidine copolymer (UVINUL 5050H available from BASF), and the like.

The N—R type hindered amine-based stabilizer may include bis(1,2,2,6,6-pentamethyl-4-piperidyl) [[3,5-bis(1,1-dimethylethyl)-4-hydroxyphenyl]methyl] butyl malonate (TINUVIN 144 available from BASF), bis(1,2,2,6,6-pentamethyl-4-piperidyl) sebacate, and methyl 1,2,2,6,6-pentamethyl-4-piperidyl sebacate mixture (TINUVIN 765, available from BASF), a polycondensate of succinic acid with dimethyl-1-(2-hydroxyethyl)-4-hydroxy-2,2,6,6-tetramethylpiperidine (TINUVIN 622SF available from BASF), N,N′-bis(3-aminopropyl)ethylenediamine-2,4-bis [N-butyl-N—(1,2,2,6,6-pentamethyl-4-piperidyl)amino]-6-chloro-1,3,5-triazine condensate (SABOSTABUV119 available from SABO S.r.l), tetrakis(1,2,2,6,6-pentamethyl-4-piperidyl) 1,2,3,4-butanetetracarboxylate (ADK STAB LA-52 available from ADEKA), 1,2,2,6,6-pentamethyl-4-piperidyl/tridecyl 1,2,3,4butanetetracarboxylate (ADK STAB LA-62 available from ADEKA), a mixed ester of 1,2,3,4-butanetetracarboxylic acid, 1,2,2,6,6-pentamethyl-4-piperidinol and 3,9-bis(2-hydroxy-1,1-dimethylethyl)-2,4,8,10-tetraoxaspiro [5,5] undecane (ADK STAB LA-63, available from ADEKA), a condensate of tetrakis(2,2,6,6-tetramethyl-4-piperidyl)-1,2,3,4-butanetetracarboxylate, 1,2,3,4-butanetetracarboxylic acid, 1,2,2,6,6-pentamethyl-4-piperidinol, and tridecyl alcohol (ADK STAB LA-63P, available from ADEKA), or 1,2,2,6,6-pentamethyl-4-piperidylmethacrylate, and the like.

The weather-resistant coating layer 10 may further include a UV reflector, a UV absorber, and the like, if necessary. In an embodiment, the weather-resistant coating layer 10 may have a content of 0.01 to 3 parts by weight, 0.01 to 1 part by weight, or 0.1 to 0.8 parts by weight with respect to 100 parts by weight of the unsaturated polyester resin.

The UV reflector may include a white pigment. For example, any one or a mixture or two or more selected from silicon dioxide (SiO₂), zirconia (ZrO₂), titanium dioxide (TiO₂), alumina (Al₂O₃), and the like may be used.

As the UV absorber, a material having properties of blocking light in the ultraviolet range, which selectively absorbs at least a part of light in the ultraviolet range of the light incident from outside and changes it into a heat form to prevent deterioration of a binder resin composition by light in the ultraviolet range, may be used. For example, any one or a mixture of two or more selected from the group consisting of a cyanoacrylate-based UV absorber, a benzotriazole-based UV absorber, a malonic acid-based UV absorber, an oxanilide-based UV absorber, a benzophenone-based UV absorber, and a triazine-based UV absorber may be used.

In an embodiment, the weather-resistant coating layer 10 may have a thickness of 60 to 100 μm, and may have better durability and improved aesthetics. However, the weather-resistant coating layer 10 may have different thickness ranges.

### Fiber-Reinforced Composite Material

In an embodiment of the present invention disclosure, the fiber-reinforced composite material 20 may include a thermoplastic resin and a reinforcing fiber, and may have improved durability and lightweight. In addition, adhesion between the weather-resistant coating layer 10 and the non-woven fabric layer 30 of the present invention disclosure is excellent, and better weatherability and mechanical properties may be achieved by a combination of the weather-resistant coating layer 10, the fiber-reinforced composite material 20 and the non-woven fabric layer 30.

In an embodiment, the fiber-reinforced composite material 20 may be obtained by laminating three or more layers of a sheet-shaped composite material in which a reinforcing fiber which is continuous and oriented in one direction is impregnated in a thermoplastic resin and combining the layers of the sheet-shaped composite material by heat. For example, 3 or more layers, for example, 3 layers, 4 layers, 6 layers, 8 layers, 10 layers, or more layers of the sheet-shaped composite material in which the reinforcing fiber oriented in one direction is impregnated may be laminated together. As the number of layers increases, durability and mechanical strength of the laminated layers may improve. In an embodiment of the present invention disclosure, 3 or 4 layers may be laminated, and the laminated layers may have sufficient mechanical strength, but the present invention disclosure is not limited thereto.

The fiber-reinforced composite material may be a laminate having two or more laminated layers of the sheet-shaped composite material in which the layers are alternately laminated and combined so that the fiber orientations of the layers cross each other. In an embodiment, in the lamination, the layers may be alternately laminated so that the fiber orientations cross each other at 0° and 90°. For example, 4 layers may have the fiber orientations that are 0°, 90°, 90°, and 0°, respectively. As such, the layers are alternately laminated so that the orientation direction of fibers cross each other at 0° and 90°, thereby providing better durability and mechanical strength.

In an embodiment, the fiber-reinforced composite material 20 may have a total thickness of 0.5 to 5 mm, 0.5 to 3 mm, 0.5 to 2 mm, 0.5 to 1.5 mm, or 0.6 to 1.2 mm, and each layer of the sheet-shaped composite material in which reinforcing fiber is impregnated before combining may have a thickness of 0.05 to 0.5 mm, 0.1 to 0.4 mm, or 0.15 to 0.3 mm.

In an embodiment, the fiber-reinforced composite material 20 may include the thermoplastic resin, and for example, may include a polyolefin-based resin such as polyethylene or polypropylene. In case where the fiber-reinforced composite material 20 includes a polyolefin-based resin, thermocompression bonding with the non-woven fabric layer 30 described below may be performed.

In an embodiment, the reinforcing fiber may be short fiber, long fiber, or continuous fiber, and the fiber-reinforced composite material 20 of the present invention disclosure may use continuous fiber as a reinforcing material. The continuous fiber means that the fiber exists in a continuous form without breaking inside depending on a final size of the composite material. For example, like the continuous fiber in a unidirection (UD) sheet, the continuous fiber may be produced by a continuous process, and by continuously supplying the continuous fiber to the continuous process, the fiber-reinforced composite material 20 including the continuous fiber may be produced.

Therefore, the fiber-reinforced composite material 20 may be produced into a product having a specific shape such as a sheet, and the continuous fiber in the product such as a sheet has a length in a specific range depending on the shape of the product. However, the continuous fiber should be regarded as having “continuity” in that the length in the specific range as such may be arbitrarily adjusted in the production process of supplying the continuous fiber, and in most cases, such as a continuous fiber in a UD sheet or a fabric, the continuous fiber has continuity without breaking inside the product.

The continuous fiber may have an average diameter of 10 to 30 μm, 12 to 18 μm, or 15 to 17 μm. In addition, the continuous fiber may be included at a content of 50 to 80 wt % or 60 to 70 wt % in the fiber-reinforced composite material. Excellent mechanical strength may be shown in the above range, however the present invention disclosure is not limited thereto.

An example of the reinforcing fiber may include glass fiber, carbon fiber, aramid fiber, and the like.

In an embodiment, the fiber-reinforced composite material 20 may further include a compatibilizer for increasing the binding force between the thermoplastic resin and the reinforcing fiber and further improving miscibility. The compatibilizer may be used without limitation as long as it is commonly used in the art, and for example, a polyolefin-based resin grafted with a carboxylic acid such as anhydrous maleic acid may be used. The content of the compatibilizer is not limited, but may be 0.1 to 30 parts or 1 to 20 parts by weight with respect to 100 parts by weight of the polyolefin-based resin.

### Surface-Treated Layer

In an embodiment of the present invention disclosure, the surface-treated layer may be further included. The surface-treated layer may be formed for facilitating application of the weather-resistant coating layer 10 and deriving a physical bond or a chemical bond with the fiber-reinforced composite material 20. In addition, it may be formed for improving a binding force to the non-woven fabric layer 30 described below as well as the weather-resistant coating layer 10.

Accordingly, the surface-treated layer may be formed on one or both surfaces of the fiber-reinforced composite material 20.

The surface-treated layer may be treated for further imparting hydrophilicity on the surface of the fiber-reinforced composite material, and for example, a plasma treatment, a corona treatment, and the like may be performed.

In the plasma treatment, for example, the fiber-reinforced composite material 20 may be plasma-treated at normal pressure to secure good appearance quality while securing sufficient adhesive strength in a range of a surface energy of 30 mN/m or more or 35 mN/m or more. The upper limit is not limited, but for example, may be 35 to 100 mN/m, but is not limited thereto.

### Non-Woven Fabric Layer

In an embodiment of the present invention disclosure, the non-woven fabric layer 30 may be formed for further improving adhesion and binding force to other materials, specifically, the insulating materials such as a polyurethane foam in the production of the exterior material.

Since the non-woven fabric layer is formed, when the composite material laminate is adhered to an insulating material such as a polyurethane foam using an adhesive, the non-woven fabric layer and an adhesive may form stable and strong adhesion due to physical entanglement of the non-woven fabric layer and an adhesive.

Though the type of non-woven fabric layer is not limited, for example, a polyester-based non-woven fabric layer may be used. For example, polyethylene terephthalate and the like may be used. In an embodiment, the polyester-based non-woven fabric layer may be a composite spun product of low-melting point polyester and high-melting point polyester. The low-melting point polyester is not limited, but may have a melting point of 140 to 160° C., and the high-melting point polyester may have a higher melting point, for example, 240 to 260° C., than the low-melting point polyester. Since the polyester-based non-woven fabric which is composite spun as described above is used, when the non-woven fabric layer is laminated on the fiber-reinforced composite material, it may be thermally adhered without a separate adhesive, and simultaneously, the mechanical strength of the composite material laminate of the present invention disclosure may be further improved.

Although a weight of the non-woven fabric layer 30 is not limited, the non-woven fabric layer may have a basis weight of 40 g/m² or more, for example, 40 to 250 g/m², 40 to 200 g/m², or 50 to 150 g/m². When the composite material laminate is used as the exterior material in the range, sufficient adhesive strength to the foam may be secured, surface cracking of the non-woven fabric layer may be sufficient strength prevented, and effects such as supplement and cost reduction may be provided. However, the present invention disclosure is not limited thereto.

### Method of Producing Composite Material Laminate

Next, the method of producing a composite material laminate of the present invention disclosure will be described.

In an embodiment, the method of producing a composite material laminate of the present invention disclosure includes producing a fiber-reinforced composite material including a thermoplastic resin and a reinforcing fiber, laminating a non-woven fabric on one surface of the fiber-reinforced composite material by thermal compression, and applying a composition including an unsaturated polyester resin and a hindered amine-based light stabilizer on the other surface of the fiber-reinforced composite material to form a weather-resistant coating layer.

In an embodiment, before forming the weather-resistant coating layer, hydrophilicizing the surface of the fiber-reinforced composite material may be further included.

In an embodiment, the hydrophilicizing may be a plasma or corona treatment.

In an embodiment, producing a fiber-reinforced composite material may include melting a resin composition including a polyolefin-based resin and a compatibilizer to produce a melt, and impregnating the melt while continuously transporting a reinforcing fiber.

For example, the resin composition including 0.1 to 30 parts by weight of the compatibilizer with respect to 100 parts by weight of the polyolefin-based resin is mixed, and then melted in an extruder for complete mixing. Next, a continuous fiber pulled out of a skein wound in a roving form is added to a mold, and the melt of the extruder is added to the mold and impregnated in the continuous fiber. Herein, the continuous fiber is added to have orientation in a single direction, and the continuous: fiber having orientation in a single direction has less bending of fibers, so that mechanical strength in a single direction may be increased. In addition, by pressing the impregnated continuous fiber by a calender process, single orientation of the continuous fiber may be easily secured. In addition, an appropriate thickness of the composite material may be formed, and a process of cutting to a predetermined size may be performed.

Thereafter, two or more layers of the cut sheet-shaped composite material may be alternately laminated so that the orientations of the fiber cross each other to produce the fiber-reinforced composite material. For example, the fiber-reinforced composite material may be a laminate in which having two or more laminated layers of the sheet-shaped composite material in which the layers are alternately laminated and combined so that the fiber orientations cross each other. In an embodiment, in the lamination, the layers may be alternately laminated so that the fiber orientations cross each other at 0° and 90°. For example, 4 layers may have the fiber orientations that are 0°, 90°, 90° and 0°, respectively. By laminating the layers so that fibers in adjacent layers cross each other at 90° and by thermally compressing the fibers, a laminate which has mechanical strength equivalent or similar to metal and has excellent durability in penetrability evaluation may be provided. In addition, a laminate which is lighter than metal may be provided.

Next, laminating a non-woven fabric by thermal compression on one surface of the produced fiber-reinforced composite material is included. The non-woven fabric is as described above.

For example, the non-woven fabric lamination may be performed by laminating and thermally compressing the non-woven fabric layers together, when several layers of sheet-shaped composite material are laminated and thermally compressed in the producing of the fiber-reinforced composite material. Otherwise, after the fiber-reinforced composite material is produced, the non-woven fabric may be subsequently laminated and thermally compressed over the fiber reinforced composite material.

The thermal compression may be performed at a melting point of the non-woven fabric layer or at a higher temperature than the melting point, for example, at 140 to 160° C., but is not limited thereto.

Next, a composition including an unsaturated polyester resin and a hindered amine-based light stabilizer is applied on the opposite surface of the surface on which the non-woven fabric layer is laminated to form a weather-resistant coating layer. Herein, the surface of the fiber-reinforced composite material may be hydrophilicized for further improving a binding force to the weather-resistant coating layer. The hydrophilicization may be the plasma treatment or the corona treatment described above.

The composition used in the weather-resistant coating layer is as described above. The application thickness of the weather-resistant coating layer may affect the weatherability of the composite material laminate of the present invention disclosure. The weather-resistant coating layer having a thickness in a range of 60 to 100 μm may provide improved weatherability and aesthetics and has smooth surface without cracks. However, the application thickness of the weather-resistant coating layer is not limited thereto.

After forming the weather-resistant coating layer, a protective film may be further laminated over the weather-resistant coating layer, if necessary. The protective film is for protecting the surface of the weather-resistant coating layer during transportation and storage. For example, a protective film may include a polyester-based film. However, the protective film is not limited thereto.

### [Exterior Material]

Another embodiment of the present invention disclosure provides an exterior material including the composite material laminate and a foam.

In an embodiment, in the exterior material, the non-woven fabric layer of the composite material laminate may be laminated to face the foam on at least one surface of the foam. Herein, lamination using an adhesive improves a chemical bond and a physical bond between the non-woven fabric layer and the foam to allow stronger adhesion.

The foam may be used without limitation as long as it is commonly used in the exterior material field. For example, a polyurethane-based foam may be used.

The exterior material may be applied to an exterior material for construction, an exterior material for a delivery container, and the like, but is not limited thereto.

Hereinafter, the examples of the present invention disclosure will be further described with reference to the specific experimental examples. It would be apparent to those skilled in the art that the examples and the comparative examples included in the experimental examples are provided to illustrate the present invention and do not limit the scope of the present invention disclosure. Various modifications and alterations of the examples may be made within the scope of the present invention.

Hereinafter, the physical properties were evaluated as follows:

### [Visual Evaluation]

Surface states before and after an accelerating weathering treatment described below were visually observed.

Defect occurrence such as exfoliation and cracks of an outermost layer was visually observed.

### [Accelerating Weathering Treatment]

Accelerating weathering evaluation was performed using a weatherability evaluation test (Ci4400) available from Atlas. The accelerating weathering evaluation was performed under light irradiation conditions of 0.5 W/m² based on 340 nm wavelength of xenon-arc lamp in which quartz (inside) and Type S borosilicate (outside) filters are combined and according to the SAE J2527 standard used in evaluation of automobile exterior materials. Light was irradiated with continuously changing humidity and temperature conditions in the order of conditions (1)->(2)->(3)->(4)->(1), as described below. The lamp was turn off only in (4) and was turned on when returned to (1) again to irradiate light.

Condition (1) includes irradiation for 40 minutes at humidity of 50% and black panel temperature of 70° C. Condition (2) includes irradiation for 20 minutes with water sprayed on surface and at black panel temperature of 70° C. Condition (3) includes irradiation for 60 minutes at humidity of 50%, and black panel temperature of 70° C. Condition (4) includes no irradiation for 60 minutes at humidity of 95% with water sprayed on surface and back surface, and at black panel temperature of 38° C. The irradiation conditions from (1) to (4) were repeated until light energy was 2500 KJ/m².

### Urethane Foam Adhesion Evaluation

As shown in FIG. 2, a composite material laminate 2 was adhered on a foamed urethane foam 1 having a thickness of 30 mm using a curable urethane adhesive so that a contact area 3 with the foamed urethane foam was 25 mm×25 mm.

After allowed to stand at room temperature for a week, the composite material laminate 2 was constantly pulled out at a tensile speed of 2 mm/min using a universal testing machine (Instron, model name: 5980). When the composite material laminate 2 was not peeled off and the foamed urethane foam 1 was separated and destroyed, it was determined to have good adhesive strength. When the composite material laminate 2 was peeled off, it was determined to have insufficient adhesive strength.

### Tensile Strength

Measurement was performed according to the evaluation rules of ASTM D3039. Universal testing machine equipment (Instron, model name: 5980) was used to measure the tensile strength with a specimen having a width of 15 mm and a length of 250 mm.

In addition, the tensile strength after the accelerating weathering treatment was measured and a tensile strength retention rate was evaluated according to the following equation:

Tensile strength retention rate (%)=tensile strength after accelerating weathering treatment/tensile strength before accelerating weathering treatment×100.

### Penetration Energy

Measurement was performed according to the evaluation rules of ISO 6603. High-speed falling ball evaluation equipment (Instron 9340) was used to measure total energy upon penetration under an impact energy of 111.0 J.

### Example 1

As a composite material substrate, glass fiber (Owens Corning, 60 wt %) impregnated in one direction in polypropylene (SK Geo Centric, HX3900, 40 wt %) to prepare a sheet-shaped composite material having a thickness of 1.2 mm. Thereafter, 4 layers of a sheet-shaped composite material were laminated so that the fiber orientations of the sheet-shaped composite materials were at 0°, 90°, 90° and 0°, respectively, using lamination equipment including two heated belts. At this time, during the combining, a composite spun non-woven fabric of low melting point PET/PET of 60 gsm (g/m²) (Toray Advanced Materials Korea) was added together to one surface to prepare a laminate in which a PET non-woven fabric was thermally compressed on one surface of the composite material substrate. Wherein the composite spun non-woven fabric is non-woven fabric composite spun with the low-melting point PET of a melting point of 150° C. and the PET having a melting point of 250° C. Normal pressure plasma equipment (available from System Korea) was passed twice in a row on the opposite surface of the surface on which the non-woven fabric was adhered to perform a corona treatment. And a composition in which 0.3 parts by weight of a hindered amine-based light stabilizer (Songwon Industrial Co., Ltd., UV 119) was mixed with respect to 100 parts by weight of unsaturated polyester (Aekyung Chemical Co., Ltd., GE-206, unsaturated polyester including 1 part by weight of white pigment) was applied at a thickness of 60 μm on the surface, and then a 50 μm PET film was laminated as a protective film to form a weather-resistant coating layer. Thereafter, curing was performed at 80° C. for 30 minutes, and aging was further performed at room temperature for 24 hours to prepare a composite material laminate.

The physical properties of the produced composite material laminate were evaluated and are shown in Table 1.

### Example 2

A composite material laminate was produced in the same manner as in Example 1, except that the basis weight of the non-woven fabric was changed to 200 gsm (g/m²).

The physical properties of the produced composite material laminate were evaluated and are shown in Table 1.

### Example 3

A composite material laminate was produced in the same manner as in Example 1, except that the basis weight of the non-woven fabric was changed to 20 gsm (g/m²).

The physical properties of the produced composite material laminate were evaluated and are shown in Table 1.

### Example 4

A composite material laminate was produced in the same manner as in Example 1, except that the basis weight of the non-woven fabric was changed to 250 gsm (g/m²).

The physical properties of the produced composite material laminate were evaluated and are shown in Table 1.

### Example 5

A composite material laminate was produced in the same manner as in Example 1, except that the thickness of the weather-resistant coating layer was 100 μm.

The physical properties of the produced composite material laminate were evaluated and are shown in Table 1.

### Example 6

A composite material laminate was produced in the same manner as in Example 1, except that the thickness of the weather-resistant coating layer was 30 μm.

The physical properties of the produced composite material laminate were evaluated and are shown in Table 1.

### Example 7

A composite material laminate was produced in the same manner as in Example 1, except that the thickness of the weather-resistant coating layer was 150 μm.

The physical properties of the produced composite material laminate were evaluated and are shown in Table 1.

### Example 8

The composite material laminate prepared in Example 1 was used to prepare a common commercial vehicle panel structure specimen in which the laminate was adhered on both surfaces of a foamed urethane foam having a thickness of 30 mm and a width and a height of 300 mm. The adhesion of the laminate and the urethane foam was performed using a thermosetting adhesive (Bostik, Marocol 18576A).

### Comparative Example 1

A composite material laminate was produced in the same manner as in Example 1, except that the weather-resistant coating layer was not formed.

The physical properties of the produced composite material laminate were evaluated and are shown in Table 1.

### Comparative Example 2

A composite material laminate was produced in the same manner as in Example 1, except that unsaturated polyester (Sewon Chemical Co., Ltd, Polystar) was used alone as the composition for forming a weather-resistant coating layer.

The physical properties of the produced composite material laminate were evaluated and are shown in Table 1.

### Comparative Example 3

A composite material laminate was produced in the same manner as in Example 1, except that the non-woven fabric layer was not formed.

The physical properties of the produced composite material laminate were evaluated and are shown in Table 1.

### Comparative Example 4

A commercial vehicle panel structure specimen was prepared in the same manner as in Example 8, except a common mild steel having a thickness of 0.5 mm was applied instead of the composite material laminate.

TABLE 1

| | Adhesive strength to urethane foam |
|---|---|
| Example 1 | Good adhesive strength |
| | (urethane foam destroyed) |
| Example 2 | Good adhesive strength |
| | (urethane foam destroyed) |
| Example 3 | Insufficient adhesive strength |
| | (flat material peeling off from urethane foam) |
| Example 4 | Insufficient adhesive strength |
| | (non-woven fabric layer broken due to insufficient |
| | penetration of adhesive into non-woven fabric layer) |
| Comparative | Insufficient adhesive strength |
| Example 3 | (Flat material peeling off from urethane foam) |

TABLE 2

| | | | Tensile |
|---|---|---|---|
| | Visual evaluation | Visual evaluation | strength |
| | before weathering | after weathering | retention |
| | treatment | treatment | rate (%) |
| Example 1 | A white exterior | Serious defects | 91% |
| | coating layer was | were not observed. | |
| | stably formed. | | |
| Example 5 | A white exterior | Serious defects | 92% |
| | coating layer was | were not observed. | |
| | stably formed. | | |
| Example 6 | Since patterns on the | Slight cracks | 91% |
| | substrate were easily | occurred. | |
| | visible as compared | | |
| | with Example 1, | | |
| | aesthetics were poor. | | |
| Example 7 | Many bubbles were | Slight cracks | 92% |
| | observed, and fine | occurred. | |
| | cracks due to | | |
| | agglomeration of the | | |
| | coating layer itself | | |
| | were observed. | | |
| Comparative | A rough surface | An orange peel was | 75% |
| Example 1 | having a remaining | observed due to | |
| | glass fiber shape was | polymer deterioration. | |
| | able to be observed. | | |
| Comparative | A white exterior | Slight cracks | 78% |
| Example 2 | coating layer was | occurred. | |
| | stably formed. | The coating layer | |
| | | was observed to be | |
| | | partially released. | |

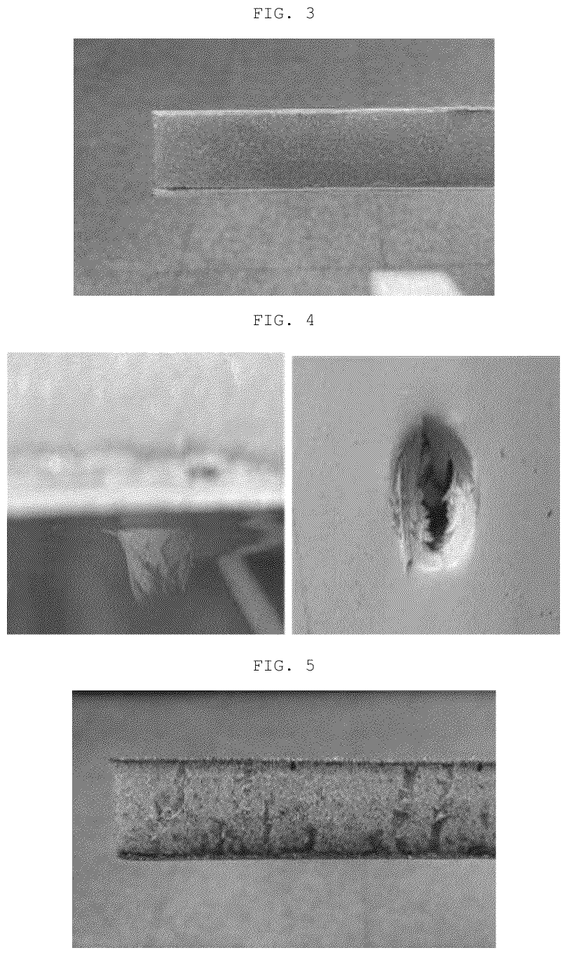

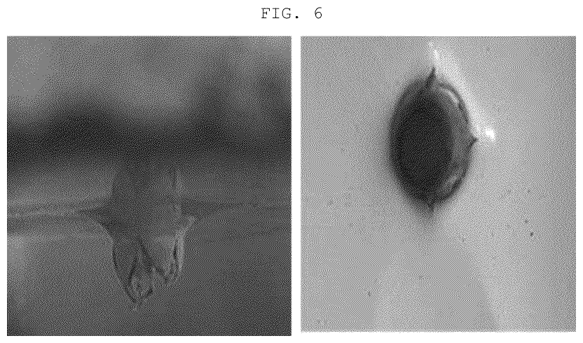

TABLE 3

| | | | Photograph of | |
|---|---|---|---|---|
| | Cross | | specimen after | |
| | section | Total | penetration | Penetration |
| | photograph | weight | evaluation | energy |
| Example 8 | FIG. 3 | 489 g | FIG. 4 | 45.549 J |
| Comparative | FIG. 5 | 847 g | FIG. 6 | 34.679 J |
| Example 4 | | | | |

As shown in Table 1, when the composite material laminate had the lamination structure of the present invention disclosure, it was confirmed that adhesive strength to the urethane foam was sufficiently secured, and the laminate may be applied to various lightweight panel. In addition, since the composite material laminate showed better adhesive strength in a range of a non-woven fabric layer basis weight of 40 to 200 gms, the urethane foam was confirmed to be destroyed without peeling off in the evaluation.

In addition, as shown in Table 2, when the weather-resistant coating layer at 60 to 100 μm was introduced on the surface of the composite material laminate, it was confirmed that mechanical tensile strength retention rate was improved even after weatherability evaluation, while improving aesthetics. However, it was confirmed that when the thickness was small at less than 60 μm, it was difficult to secure aesthetics, and on the contrary, when the thickness is too large at 100 μm or more, problems such as cracks occurred due to its excessive self-cohesiveness.

When the composite material laminate disclosed in the present invention was applied to a common light panel structure and compared with a common structure to which a conventional mild steel (mild steel plate) was applied, it was confirmed that a lightweight of about 42% was allowed and impact properties were greatly improved, as shown in Table 3.

The above description is only an example to which the principle of the present invention disclosure is applied, and other constitution may be further included without departing from the scope of the present invention.

Since the composite material laminate according to an embodiment of the present invention disclosure is light, has high strength, has low surface roughness to have excellent aesthetics, and has excellent durability and weatherability, it may replace a metal panel for an exterior material.

In addition, when the composite material laminate according to an embodiment of the present invention disclosure is adhered to an insulating material such as a polyurethane foam using an adhesive, stable adhesion is allowed due to physical entanglement of a non-woven fabric layer and the adhesive, and an excellent adhesion effect may be provided.

In addition, the exterior material using the composite material laminate according to an embodiment of the present invention disclosure may be used in a lightweight container wall body of a commercial vehicle and the like to provide high rigidity and lightweight, and may provide a fuel efficiency reduction effect.

Hereinabove, although the present invention disclosure has been described by the specific examples and embodiments with accompanying drawings in the present invention disclosure, they have been provided for assisting the understanding of the entire scope of the present invention disclosure. Therefore, the present invention is not limited to the embodiments described herein, and present invention disclosure it would be apparent to those skilled in the art that various modifications and changes may be made without departing from the scope of the present invention disclosure.

### LIST OF NUMERALS IN THE FIGS.

10: weather-resistant coating layer
20: fiber-reinforced composite material
30: non-woven fabric layer

What is claimed is:

1. A composite material laminate comprising:
a fiber-reinforced composite material including a sheet-shaped composite material in which a thermoplastic resin is impregnated in a reinforcing fiber which is continuous and oriented in one direction;
a weather-resistant coating layer disposed on one surface of the fiber-reinforced composite material; and
a non-woven fabric layer disposed on the other surface of the fiber-reinforced composite material.

2. The composite material laminate of claim 1, wherein the fiber-reinforced composite material includes a surface-treated layer which is plasma or corona-treated on a surface on which the weather-resistant coating layer is disposed.

3. The composite material laminate of claim 1, wherein the weather-resistant coating layer is formed of a composition including an unsaturated polyester resin and a hindered amine-based light stabilizer.

4. The composite material laminate of claim 3, wherein the weather-resistant coating layer has a thickness of 60 to 100 μm.

5. The composite material laminate of claim 3, wherein the weather-resistant coating layer further includes a white pigment.

6. The composite material laminate of claim 1, wherein the non-woven fabric has a basis weight of 40 g/m² or more.

7. The composite material laminate of claim 1, wherein the fiber-reinforced composite material is a laminate of three or more layers of the sheet-shaped composite material.

8. The composite material laminate of claim 7, wherein the fiber-reinforced composite material is a laminate of two or more layers of the sheet-shaped composite material in which the fiber orientations of the layers cross each other.

9. The composite material laminate of claim 8, wherein in the lamination, the fiber orientations of the layers cross each other at an angle of 0° or 90°.

10. The composite material laminate of claim 1, wherein the fiber-reinforced composite material has a content of the reinforcing fiber of 50 to 80 wt %.

11. The composite material laminate of claim 1, wherein the thermoplastic resin of the fiber-reinforced composite material is polyethylene or polypropylene.

12. An exterior material comprising the composite material laminate of claim 1 and a foam.

13. The exterior material of claim 12, wherein in the exterior material, the non-woven fabric layer of the composite material laminate is laminated to face the foam on at least one surface of the foam.

14. A method of manufacturing a composite material laminate, the method comprising:
laminating a non-woven fabric on one surface of a fiber-reinforced composite material in which two or more layers of a sheet-shaped composite material are laminated by thermal compression, and
applying a composition including an unsaturated polyester resin and a hindered amine-based light stabilizer on the other surface of the fiber-reinforced composite material to form a weather-resistant coating layer,
wherein the sheet-shaped composite material is formed by impregnating a thermoplastic resin in a reinforcing fiber, and
wherein the reinforcing fiber is continuous and oriented in one direction.

15. The method of manufacturing a composite material laminate of claim 14, further comprising: before forming the weather-resistant coating layer, hydrophilicizing the surface of the fiber-reinforced composite material.

16. The method of manufacturing a composite material laminate of claim 15, wherein the hydrophilicizing is a plasma or corona treatment.

17. An exterior material comprising:
a composite material laminate; and
an insulating material,
wherein the composite material laminate includes:
a fiber-reinforced composite material having sheet-shape and including a thermoplastic resin impregnated with reinforcing fibers;
a weather-resistant coating layer disposed on a first surface of the fiber-reinforced composite material; and
a non-woven fabric layer disposed on a second surface of the fiber-reinforced composite material,
wherein the fiber-reinforced composite material is a laminate of two or more layers of the sheet-shaped composite material,
wherein the layer includes continuous fibers oriented in one direction,
wherein fiber orientations of the layers cross each other at an angle of 0° or 90°.
